(19) United States
(12) Patent Application Publication
(10) Pub. No.: US 2024/0411950 A1
(43) Pub. Date: Dec. 12, 2024

(54) ACCESS CONTROLLED POWER GRID MODEL

(71) Applicant: X Development LLC, Mountain View, CA (US)

(72) Inventors: Hamed Khalilinia, San Mateo, CA (US); Raymond Daly, Palo Alto, CA (US); Arthur Robert Pope, Palo Alto, CA (US); Sushant Kumar, San Jose, CA (US); Sergei Babinskii, Mountain View, CA (US); Phillip Ellsworth Stahlfeld, Mountain View, CA (US); Laura Elizabeth Fedoruk, Burlingame, CA (US); Aryeh Benjamin Hillman, Santa Cruz, CA (US)

(21) Appl. No.: 18/741,651

(22) Filed: Jun. 12, 2024

Related U.S. Application Data
(60) Provisional application No. 63/507,717, filed on Jun. 12, 2023.

(51) Int. Cl. G06F 30/18

(52) U.S. Cl. CPC G06F 30/18

(57) ABSTRACT

Methods, systems, and apparatus, including medium-encoded computer program products, for an access controlled power grid model. A power grid model can include multiple regions. Access can be provided only to a subset of regions based on access privileges, and the user can be denied access to regions of the power grid model outside of the subset. A simulation can be executed using input from the user and can include simulation parameters for at least one of the regions in the subset. The simulation can be executed on the regions of the power grid model in the subset and at least one additional region that is not in the subset. The simulation can produce results that can include electrical values of components in the regions within the subset and values of components in at least one additional region. The output can include only the simulation results for regions within the subset.

### CROSS-REFERENCE TO RELATED APPLICATION

This application claims priority to U.S. Provisional Application No. 63/507,717, filed on Jun. 12, 2023. The disclosure of the prior application is considered part of and is incorporated by reference in the disclosure of this application.

### TECHNICAL FIELD

This specification relates to techniques for maintaining, updating and simulating models of electrical power grid systems, and more specifically to maintaining, updating and simulating the operation of an electrical power grid while enforcing access controls.

### BACKGROUND

Electrical power grids are interconnected networks of power sources, power loads, and power delivery and regulating components. The delivery of electricity over a power grid can include transmission, which typically occurs at high voltage and over large distances, and distribution, which typically occurs at lower voltage and over shorter distances. For example, a power plant can generate electricity, which is then stepped up to high voltage for long distance transmission, and then stepped down at substations for low voltage distribution. The distribution system can then distribute power to local homes and businesses.

### SUMMARY

This specification relates to techniques for maintaining, updating, and simulating model(s) of electrical power grid systems, where the electrical power grid includes regions, and access limits for each region's data are enforced by an access control mechanism. Users can run simulations for some or all regions of the grid model, but access detailed simulation results only as access control policies permit.

Particular embodiments of the subject matter described in this specification can be implemented so as to realize one or more of the following advantages. The techniques described below can be used to limit access to regions of a grid model to authorized users, while enabling such users to perform simulations that include regions to which the users are not authorized to perform operations other than simulations. These techniques allow users to perform simulations that can inform decisions relating to safety and efficiency without compromising security and confidentiality for larger sections of the electrical grid. In addition, the techniques enable regions to be specified flexibly, including specifying regions that are geographically fixed and described using other specifications. In addition, simulation results can be provided according to a user's level of access. For example, some users might receive granular simulation detail for multiple regions, some might receive granular simulation detail only for a single region, and others might receive detail for no regions, receiving instead only coarse simulation results.

In general, innovative aspects of the subject matter described in this specification can be embodied in methods that include accessing a power grid model that represents a power grid and electrical specifications of grid components. The power grid model can include multiple regions. Responsive to an access request from a user, access can be provided only to a subset of the regions based on access privileges associated with a user account. In some implementations, the user is not permitted to access other regions of the power grid model outside of the subset. In some implementations, a simulation of the power grid model can be executed using input from the user. The input indicates simulation parameters for at least one of the regions in the subset, and the simulation is executed on the regions of the power grid model in the subset and at least one additional region that is not in the subset to produce simulation results including electrical values of components in the regions of the power grid model within the subset and electrical values of components in the at least one additional region. The simulation results of electrical values of components in the regions of the power grid model within the subset is provided as output. In some implementations, at least one change to the power grid model can be received from a user; and responsive to verifying that the at least one change is associated with the at least one region in the subset of regions of the power grid model, the power grid model can be updated to incorporate the at least one change. Other implementations of this aspect include corresponding systems, apparatus, and computer programs, configured to perform the actions of the methods, encoded on computer storage devices.

These and other implementations can each optionally include one or more of the following features. At least one change to the power grid model can be received from the user, and responsive to verifying that the at least one change is associated with the at least one region in the subset of regions of the power grid model, the power grid model can be updated to incorporate the at least one change.

In some implementations, each region can be an area of space that is defined by fixed boundary points. The fixed boundary points can be geographic coordinates.

In some implementations, each region can be an area of space that is defined by an identifier.

In some implementations, access can be provided only to a result subset of the simulation results based on access privileges associated with a user account.

In some implementations, the result subset can include simulation results at a boundary of a region of the regions of the power grid model.

In general, innovative aspects of the subject matter described in this specification can further be embodied in methods that include obtaining a power grid model that represents a power grid and electrical specifications of grid components. The power grid model can include multiple regions. Responsive to an access request from a user, access can be provided only to a subset of the regions based on access privileges associated with a user account. In some implementations, the user is not permitted to access other regions of the power grid model outside of the subset. At least one change to the power grid model can be received from a user, and responsive to verifying that the at least one change is associated with at least one region in the subset of regions of the power grid model, the power grid model can be updated to incorporate the at least one change. Other implementations of this aspect include corresponding systems, apparatus, and computer programs, configured to perform the actions of the methods, encoded on computer storage devices.

These and other implementations can each optionally include one or more of the following features. A user group associated with the user and access permissions for the user group can be determined. Using the access permissions, it can be determined that at least one change is permitted.

In some implementations, a user group associated with the user and access permissions for the user group can be determined. It can be determined that the access permissions do not permit the at least one change.

In some implementations, responsive to determining that the access permissions do not permit the at least one change, an access notification can be provided and can indicate that access was denied to the user.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an environment for providing an access controlled power grid model.

FIG. 2 is a flow diagram of an example process for providing an access controlled power grid model.

FIG. 3 is a block diagram of an example computer system.

Like reference numbers and designations in the various drawings indicate like elements.

### DETAILED DESCRIPTION

Electrical power grids include a broad range of interconnected components that can be organized into two broad categories: transmission components that deliver power from power generation along high voltage wires across long distances to substations, and distribution components that distribute power from substations to endpoints such as homes and businesses. Some elements, such as substations, participate in both transmission and distribution. The components can be of various types such as inverters (Solar, Wind, HVDC, etc.), relays, Power Plant Controllers (PPCs), Energy Management Systems, Remedial Action Systems (RAS), Automatic Generator Controls, alarm systems and so on.

The operation of one component often influences the operation of other components. For example, a PPC regulates and controls networked inverters within a power plant. In addition, various components can operate differently under different load conditions. Further, the output of one component can influence the load of other components. Understanding how the totality of components in the grid operate can aid in proper grid operation.

Simulations can be used to estimate how various components will operate under such varying load conditions. The model used for simulation can be called a power grid model (or “grid model,” for brevity), which can operate on a grid model or on a subset of a grid model. A grid model can span the totality of components from generators to end loads (e.g., households, businesses, factories, etc.). A model can be a software representation (e.g., text, code, or other computer data structure representation) of power system components and electrical networks that can include mathematical representations of the components used for simulation and analysis. Physical components of the electrical grid can be represented by elements of the grid model, and simulations can be performed on such grid models.

In some cases, a grid model is actually a composite of multiple regional grid models, each owned and operated by distinct entities, such as power companies. Since the internal operation of a region can be considered proprietary information, some operators will disallow access to details of their grid regions. For example, regulations might forbid general access to power data and/or the data might contain proprietary information that the operator might choose not to disseminate.

However, since regions of the grid are interconnected, the operation of one grid region impacts the operation of other regions. Therefore, when the operator of a grid region performs a simulation of a proposed change to a region under its control, the simulation requires inclusion of other regions. Yet, as noted above, some operators will decline to release data necessary for another operator to perform such simulations.

This specification describes techniques in which a grid model can include multiple regions, and the data for each region can be controlled by the operator providing the data. Each operator can establish access control policies for the region that define operations available to other operators. The access control policies can specify what data can be accessed, for what purposes, by which operator(s), and at what level of granularity it can be accessed, among other factors. For example, a policy can specify that any operator can access data relating to electrical components at the boundary of a region (e.g., where such components interface with components in another region), and can perform simulations using granular data within a region and report results of the simulation, but cannot reveal information describing the details of the simulated operation within a region.

The grid model can be contained on a single server, a server complex provided by a single entity (e.g., a Cloud computing provider), or federated across servers provided by multiple entities (e.g., the grid operators or providers to the operators). Similarly, simulations can be performed using one or multiple servers operated, or under control of, one or multiple computing providers.

To perform simulations, as described further below, a system can access a power grid model that contains multiple regions. When the system receives a request from a user to run a simulation, the system can determine the access permissions for the user, and provide access only to the regions to which the user has been granted access. Once the system has determined access permissions, the system can perform a simulation using simulation parameters (e.g., minimum load, maximum load, etc.) provided by the user. Although the user may only have access to a limited number of regions, the simulation can be executed on a larger scale, to include regions of the model that the user does not have access to, e.g., to improve the overall accuracy of the simulation results. For example, the simulation can be performed on the full model. Once the system has completed the simulation, the system can provide output to the user, where the output depends on the access permissions of the user. For example, some users might have access only to the simulation results for a region with which the user is affiliated (e.g., the user is an agent of the region's operator), while other users (e.g., regulators) might have access to the detailed operation of all components in all regions.

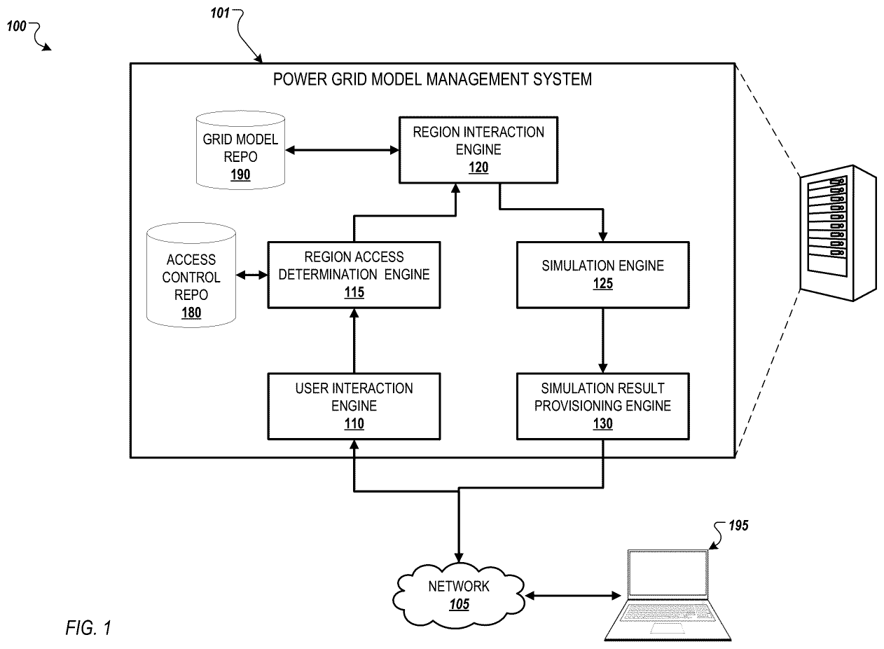

FIG. 1 shows a block diagram of an environment for providing an access controlled power grid model. The environment 100 includes an electric grid model management system 101 (“grid management system 101,” for brevity), client devices 195 and a data communication network 105, such as a local area network (LAN), a wide area network (WAN), the Internet, a mobile network, or a combination thereof. The data communication network 105 connects client devices 195 to the grid management system 101.

A client device 195 is an electronic device that is capable of communicating over the network 105. Example client devices 195 include personal computers, server computers, mobile communication devices, e.g., smart phones and/or tablet computers, and other devices that can send and receive data over the network 105. A client device 195 can also include a digital media device, e.g., a streaming device that plugs into a television or other display to stream videos to the television or a virtual reality system.

The grid management system 101 can include a user interaction engine 110, a region access determination engine 115, a region interaction engine 120, a simulation engine 125, a simulation result provisioning engine 130, and data repositories such as an access control repository 180 and a grid model repository 190.

The user interaction engine 110 can receive user access requests (“requests,” for brevity) from users of client devices 195 over the network 105. The user interaction engine can provide an application programming interface (API) that is configured to receive access requests over the network 105, and the API can take various forms such as a web services API and a remote procedure call API.

A request can specify various information describing the operation the user is asking to perform and information associated with the user making the request. For example, a request can include a user identifier for the requesting user, the region or regions on which the operation is to be performed, the operation or operations, the user groups to which the user is assigned, authorization information (e.g., a password or authorization token), and so on. When the request is a request to update a component of the grid model, the request can specify the piece or pieces of equipment to update and the update requested. The request can also specify that a change (e.g., increasing values by 10%) is to apply to all relevant components. The update can be specified as a value (e.g., a particular voltage or current), specified a change (e.g., increase by 10%), or using other specification techniques. Requests can be encrypted, e.g., by transmitting the request using the HyperText Transfer Protocol-Secure, to provide security for the request, including any authorization information.

In some implementations, a request can include a user identifier, and the system can use the user identifier to determine the user group(s) to which the user identifier is assigned. For example, the grid management system 101 can include, or be coupled to, a database that stores the user groups to which a user identifier is assigned. In some implementations, instead of, or in addition to, including the user identifier in the request, the user identifier can be implicit, e.g., obtained from a session identifier associated with the communication between the client device 195 and the grid management system 101. For example, a user might log onto the grid management system 101 by providing a user identifier and password, and requests provided over that session are associated with the user identifier provided at login.

The region access determination engine 115 can accept access requests from the user interaction engine 110 and determine whether the request is authorized to access the power grid model, and if so, determine access to which regions of the power grid model are authorized. The region access determination engine 115 can use access control entries that are stored in the access control repository 180.

Access control entries stored in the access control repository 180 can describe access permissions for groups of users (where a single user can be considered a group of one) of the system. An access control entry can describe, for a group of users, what access permission(s) are granted for one or more regions. Access control entries can also specify default settings, such as any group of users can read (but not alter) data about any region. In another example, a default setting can specify that no access is permitted unless an access control entry explicitly grants such access. Access permissions can include, for example, read, modify, delete and use in simulation.

In some implementations, access control entries can specify access permissions for a group of users that share a role or set of roles, where a role can be specified as a user group. For example, an access control entry can specify that any user with the “region administrator” role can perform any action (that is, is granted all permissions) on the data for a region. The grid management system 101 can include a repository that maps user identifiers to roles.

Access control entries can be represented using a variety of formats. For example, access permissions can be expressed as tuples such as {UserGroup, Region, Permission}. In another example, access control entries can be represented as conditional statements, such as “if ((UserGroup==Group1) AND (Region==Region 7)) THEN Permission=READ,” which can be interpreted as the UserGroup called Group 1 has READ permission for data relating to the region called Region7.

Permissions can specify the actions a UserGroup can perform on a region. As noted above, permissions can include reading, modifying, deleting, adding, simulating, etc. Default permissions can also be configured. For example, the grid management system 101 can be configured such that all UserGroups can perform simulations using all regions, unless an access permission explicitly denies access. Access permissions can also include negative permissions where a UserGroup is explicitly denied a permission. For example, an access permission might specify {UseGroup1, Region3, NOT_READ} to indicate that members of UserGroup1 cannot read data describing Region3.

Permissions can further specify whether and to what level of granularity the simulation results can be provided. For example, permissions might specify “ALL”, indicating that the UserGroup is authorized to see simulation results at any level of detail. In another example, permissions might specify “BOUNDARY” indicating that the UserGroup is authorized to see the results of the simulation only at the boundary of the region, and not for the interior component of a region. As noted above, a boundary can be defined as an electrical component in a region that is directly coupled to at least one electrical component that is not in the region. In still another example, permissions can indicate time granularity for a simulation. For example, permissions might specify that a UserGroup can see all intermediate results for a region, only results at the completion of a simulation, a configured number of intermediate results (e.g., one intermediate result, two intermediate results, etc.), and so on.

The term “region” can refer to a collection of electrical grid assets, and the assets can be specified using a variety of techniques. For example, a region can be an area of space that is defined by fixed boundary points, such as geographic coordinates, or by an identifier, such as an identifier for a room or other area of a ship, aircraft or other moving or stationary object. In still another example, a region can be defined by characteristics that can vary over time, such as an area to which power is provided by a given power provider. In still another example, a region can describe a topology of electrical grid assets, such as all assert connecting two feeders. A region can also be specified using a combination of approaches, such as all assets between two feeders that are within the geographical boundary of a particular town. Other techniques for identifying regions can also be used.

In some implementations, regions can be identified by tokens that are mapped to areas by the grid management system 101. For example, the system can translate the token “California” to the area of space in the state of California and “Boulder, CO” to the area of space in the city of Boulder, Colorado.

The region access determination engine 115 can provide descriptions of allowable access of the regions to the region interaction engine 120. The region interaction engine 120 can obtain data describing a power grid from the grid model repository 190, and update the data according to the access request and the access control information provided by the region access determination engine 115.

The grid model repository 190 can store data describing a power grid. A power grid can be an electrical power grid that transmits electrical power to loads such as residential and commercial buildings, and a grid model can include a model of real-world power grid assets. The grid model can include a topological representation of the power grid, electrical specifications of grid components, and empirical operation characteristics. As described above, grid models can be specific to a particular region (e.g., a particular city) or electrical region (e.g., particular electrical feeder(s)). The grid model can also optionally include a model of one or more previously proposed interconnections to the power grid, e.g., proposed interconnections that have not yet been built. The detail of the grid model is sufficient to allow for accurate simulation and representation of steady-state, dynamic and transient operation of the grid.

In some examples, the grid model can include a complete electrical model of a feeder to which the proposed interconnection will connect. For example, the grid model can include a high resolution electrical model of one or more electrical distribution feeders. The grid model can include, for example, data models of substation transformers, distribution switches and reclosers, voltage regulation schemes, e.g., tapped magnetics or switched capacitors, network transformers, load transformers, inverters, generators, and various loads. The grid model can include line models, e.g., electrical models of medium voltage distribution lines. The grid model can also include electrical models of fixed and switched line capacitors, as well as other grid components and equipment.

The line models can include multiple segments that can represent interconnections between poles. In the case of underground lines, the segments can represent interconnections between risers or between underground connections such as transformers and meters. In some examples, the line models can be represented by equivalent inductors and resistors and capacitors for associated line lengths. In some examples, the line models can include models of mutual inductance between lines, capacitance between lines, and capacitance from the lines to ground. Line model attributes can be based on the line's connection type and on the type of conductors used. Line model attributes can also be based on construction details, e.g., whether the lines are overhead or underground.

The grid model can be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, possibly averaged over multiple years, or otherwise represented statistically.

In some examples, the grid model can include assumptions. For example, the grid model can include measured data for certain locations of the power grid, and might not include measured data for other locations. The grid model can use assumptions to interpolate grid operating data for locations in which measurements are not available. An assumption can be, for example, an assumed ratio or relationship between loads at industrial locations of the power grid compared to residential locations of the power grid, or assumptions for load growth due to climate change.

In some examples, the grid model can include measured data for certain time intervals, e.g., certain hours, and might not include measured data for other time intervals. The grid model can use assumptions to estimate or interpolate grid operating data for time intervals in which measurements are not available. An assumption can be, for example, an assumed relationship between loads at a particular location at nighttime compared to daytime. In another example, an assumption can be an assumed relationship between loads at a particular location during an hour of the day in summertime, compared to during the same hour of the day in wintertime.

In some examples, the grid model can include measured data for certain characteristics, e.g., electrical load, and might not include measured data for other characteristics. The grid model can use assumptions to estimate grid operating data for characteristics for which measurements are not available. An assumption can be, for example, an assumed relationship between load and voltage at a particular location of the power grid.

In some examples, measured data can be used to resolve and reduce errors caused by assumptions in the grid model. In some examples, the grid model can include conservative values in place of missing or incomplete data. In some examples, the grid model can use worst case assumptions to enable worst case analysis.

Data repositories, such as the grid model repository 190 and the access control repository 180 can be any appropriate data storage systems such as a relational database, an object database, a file system, block storage and/or combinations of data storage systems. Further, while the data repositories are shown as being inside the grid management system 101, each data repository can be outside of, and coupled to, the grid management system 101.

The region interaction engine 120 can provide the modified grid model to the simulation engine 125, which can perform simulations using the modified grid model and provide the simulation results to the simulation result provisioning engine 130

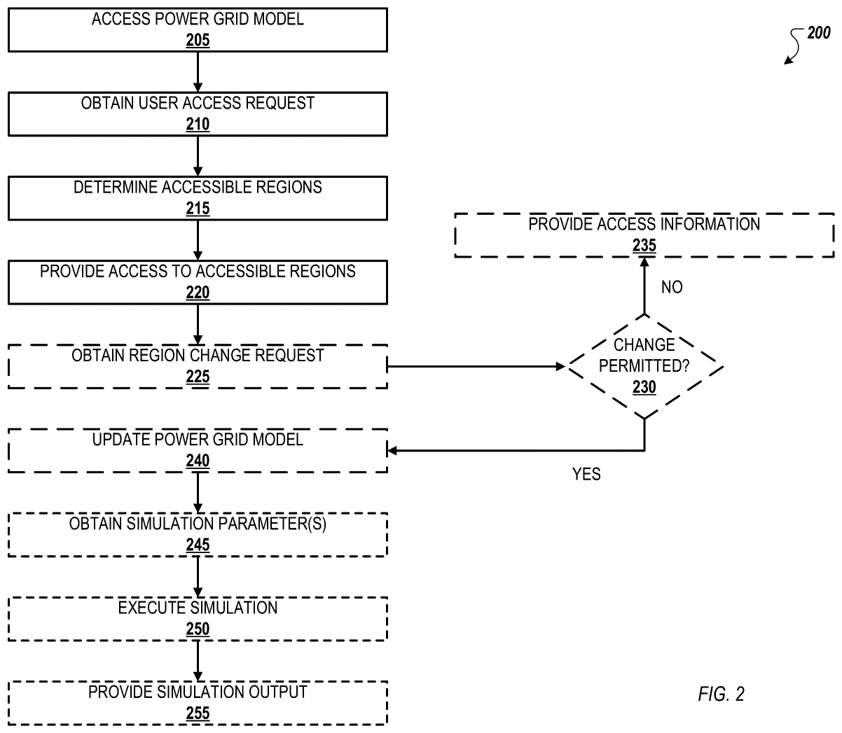

The simulation result provisioning engine 130 can make the simulation results available to authorized parties. For example, the simulation result provision engine 130 can provide the simulation results through the network 105 to the client device 195. In another example, the simulation result provisioning engine 130 can store the simulation results in a repository such as a relational database, an object database, block storage, a file system, and other appropriate repositories. The simulation result provisioning engine 130 can further adjust the simulation results according to access permissions associated with a user group, as described further in reference to FIG. 2.

FIG. 2 is a flow diagram of an example process for providing an access controlled power grid model. For convenience, the process 200 will be described as being performed by a system for providing an access controlled power grid model, e.g., the grid management system 101 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system can obtain (205) a power grid model. In some implementations, the system can obtain the power grid model from a grid model repository using techniques appropriate for the repository. For example, if the grid model repository is a relational database, the system can obtain the model using Structured Query Language (SQL) operations. In another example, if the repository is a file system, the system can obtain the model using file system operations. In a further example, the repository can provide an API configured to provide power grid models, and the system can obtain the power grid model using that API.

The system can obtain (210) a user access request, e.g., by including an API that is configured to accept user access requests. The API can be a web services API or a Remote Procedure Call (RPC) interface, among other examples. The system can obtain the user access request when a user calls the API and provides the request. In another example, the system can obtain a user access request by accepting messages transmitted over HTTP-S that include the user access request.

The system can determine (215) accessible regions. The system can determine the user groups associated with the request, and use the users groups to determine accessible regions. In some implementations, the request can include the user groups for the request. In some implementations, the request can include a user identifier, and the system can use the user identifier to determine user groups, e.g., as described in reference to FIG. 1.

The system can use the user groups to determine accessible regions. The system can use data provided by an access control repository to determine the regions and access permissions associated with the user groups determined from the request. For example, the system can query the access control repository, providing the user group(s), and receive in response the regions to which the user group(s) have access, and for each region the permission(s) granted to the user group for the region. In the case where multiple user groups are provided, and the access control repository provides multiple responses, the system can determine that the accessible regions include the union of the regions provided by the access control repository, and for each such region, the permissions can be the union of permissions received. The system can then provide (220) access to those accessible regions according to the permissions, as described further below.

In some cases, the system can obtain (225) one or more region change requests. In some implementations, the change request can be included in the user access request obtained in operation 210. In some implementations, the user access request of operation 210 can be a simulation request, and the system can obtain a region change request that is separate from the user access request of operation 210. In such cases, the system can include an API, such as a web services API or RPC, which is configured to accept region change requests. In some implementations, the user access request of operation 210 can include both a region change request and a simulation request, and the system can obtain the region change request from the user access request.

In some cases, the system will obtain only simulation parameters relating to a simulation request (e.g., as described in reference to operation 245), and not obtain a change request. In such cases, the operations 225, 230, 235 and 240 can be omitted as the request relates only to a simulation.

The system can determine (230) whether the change is permitted by comparing access permissions of the accessible regions for a user group determined in operation 215 to the change requests for the regions determined from the region change request. For example, if the change request specifies an update to a component (e.g., an update to a maximum voltage of a transformer) in a region, and the access permission (e.g., determined from information provided by an access control repository) specifies that the user group of the change request has update permission for the region, the system can determine that the change is permitted. Conversely, if the access permission does not specify that the user group of the change request has update permission for the region, then the system can determine that the change is not permitted. If the change is permitted, the system can proceed to operation 240; if the change is not permitted, the system can proceed to operation 235.

The system can provide (235) an access notification indicating that access was denied to the user. The access notification can include an indication that the change is not permitted by the user. The system can provide the access notification using various techniques including transmitting a message to a management console, providing a failure code in response to an API call, and/or sending an e-mail or text message, among other techniques. Once the notification has been provided, the system can cease operation on this request as the access has not been authorized. In some implementations, the system can return to operation 210 to obtain new user access requests. In some implementations, the system can cease operation.

The system can update (240) the power grid model. The request can specify the component or components to be updated and the update to be made, e.g., as described in reference to FIG. 1. The system can apply the updates to the components of the grid model as specified in the request, e.g., by changing values associated with components, adding one or more components and/or removing one or more components.

The system can obtain (245) simulation parameters using various techniques. For example, the simulation parameters can be included in the user access request. In another example, the system can provide an API, which, when called by a user, enables the user to provide the simulation parameters to the system.

The simulation parameters can include any data relevant to a simulation. For example, simulation parameters can include simulated changes to interconnections (e.g., adding a component, removing a component, altering connections among components, etc.), load parameters (e.g., length, power, and number of loads of a component such as a distribution feeder), fault conditions (e.g., a component becomes non-operational), the time over which the simulation is to be performed, the type of simulation to be performed (e.g., power flow, positive sequence, etc.), and so on.

The system can execute (250) a simulation of the power grid model using input from the user, which can include the simulation parameters obtained in operation 245. The simulation parameters can apply to at least one of the regions in the subset of regions which the system has determined is accessible to the user (e.g., in operation 215).

The simulation can be performed using various subsets of the grid model. For example, the simulation can be performed on regions for which the user does not have permission to access, view, and/or modify. For instance, the simulation can be performed using the entire grid model because electric grid behaviors/operations in other connected portions of the grid may affect operations in the regions of the grid model that the user is permitted to access. Therefore, a user can, in some implementations, perform a simulation using a region of a grid model, even if the user has not been provided access to the region. The simulation can produce simulation results including electrical values of components in the regions of the power grid model within the subset and electrical values of components in at least one additional region, as described further below.

The simulation can be based on, for example, root-mean-square (RMS), power flow, positive sequence, and/or time series voltage transient analysis. In some implementations, the system can simulate only the modified grid model that exists after all proposed interconnections have been applied. In some implementations, the system can simulate each of the multiple modified grid models that are created as proposed interconnections (e.g., as included in the simulation parameters) are applied sequentially. Such a simulation approach provides impact assessments for each stage, capturing both interim benefits and risks that might not be expressed in the final impact assessment. In some implementations, the system can simulate a subset of the multiple modified grid models that are created as the proposed interconnections are applied sequentially.

For each simulation, the simulation system can conduct comprehensive interconnection evaluations using a reduced set of input data. The interconnection simulation system can perform rapid speed simulation over a variety of dynamic power grid operating conditions over a simulated period of time, e.g., based on historical power grid data. The simulation can include predicted operating conditions over discrete time intervals, e.g., over each hour of a simulated year.

The simulation system can simulate how interconnection and other alterations to the grid impacts on the electrical grid under various predicted load conditions, including variations due to factors such as seasonal effects, calendar effects, and time of day effects. The simulation system can simulate interconnection impacts at multiple locations of the electrical grid. The simulation system can simulate various electrical operating characteristics, e.g., current, voltage, power factor, load, etc. at multiple locations, over prolonged simulated periods of time.

In one example, the amount of data processed during each simulation can depend on the size and framework of the distribution feeder and any proposed interconnection included in the simulation parameters. The simulation can analyze predicted effects for all connections to the affected distribution feeder and all components of the affected distribution feeder. Thus, the complexity of simulations can vary depending on construction of a distribution feeder in the regions including in the simulation.

The simulations can vary depending on length, power, and number of loads of a distribution feeder. A typical distribution feeder can range in length from approximately one mile to ten miles. A typical distribution feeder can range in power from approximately one to ten megawatts. The number of loads connected to a feeder can range from a few hundred residential loads to several thousand residential loads. In some cases, there may also be as few as a few dozen commercial or industrial loads, and as many as hundreds of commercial or industrial loads.

The system can provide (255) the simulation output using various techniques. For example, the system can provide the simulation output to a storage system such as a relational database, a file system or a block storage system. In another example, the system can provide the simulation results to a web server. In a further example, the system can provide the simulation output, or a reference to a location that contains the simulation output, in response to the request to perform the simulation.

In some implementations, the system can provide simulation output based on access permissions associated with a user account. The system can determine access permissions associated with a user account, e.g., by using the user account to determine user groups associated with the user account, and use the user groups to determine access permissions. As described in reference to FIG. 1, access permissions can include the level of granularity of simulation results that can be provided to the user.

The system can adapt the simulation results to the permitted level of granularity. For example, if the access permissions specify that, for a region R, the user can only receive boundary results, the system can provide the simulation results at the boundary, and provide no further simulation results. In another example, if the access permissions specify that a user can receive only final results, and not intermediate results, the system can provide only the final results. In still another example, the user might be authorized to see only one metric, such as maximum current at an electrical element in a region, and the system can provide only that maximum current. In a further example, a user might be permitted to see only coarse results, such as whether the simulation produced an error condition (e.g., a maximum voltage exceeding a threshold value), and the system can provide only an indication of whether such an error condition occurred. In general, access permissions can specify any restriction on simulation results provided to a user.

In some cases, the request will specify an update to a power grid model, and not include a request to perform a simulation. In such cases, operations 245, 250 and 255 can be omitted for the request, and the system can perform operations 225, 230, 235, and 240.

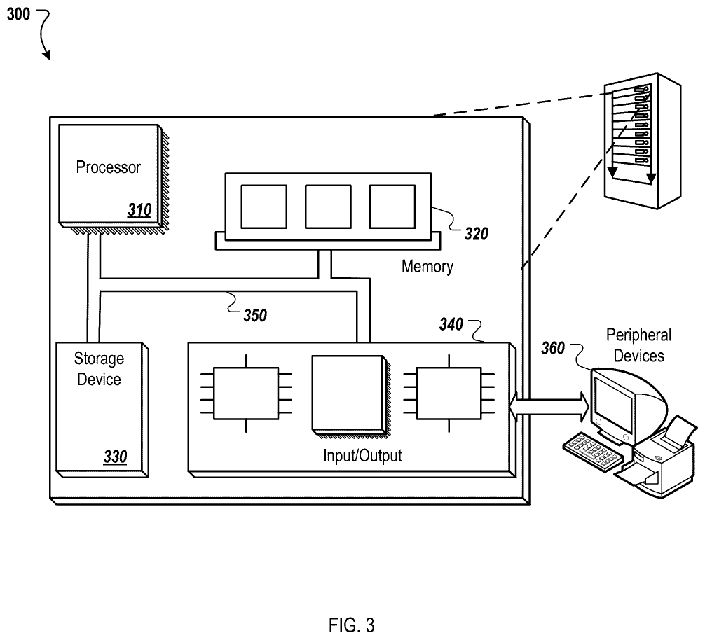

FIG. 3 is a block diagram of an example computer system 300 that can be used to perform operations described above. The system 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 can include, for example, a hard disk device, an optical disk device, a storage device that is shared over a network by multiple computing devices (e.g., a cloud storage device), or some other large capacity storage device.

The input/output device 340 provides input/output operations for the system 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable

Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In addition to the embodiments described above, the following embodiments are also innovative:

Embodiment 1 is a computer-implemented method comprising: accessing a power grid model that represents a power grid and electrical specifications of grid components, the power grid model comprising a plurality of regions; responsive to an access request from a user, providing access only to a subset of the regions based on access privileges associated with a user account, wherein the user is not permitted to access other regions of the power grid model outside of the subset; executing a simulation of the power grid model using input from the user, the input indicating simulation parameters for at least one of the regions in the subset, the simulation executed on the regions of the power grid model in the subset and at least one additional region that is not in the subset to produce simulation results including electrical values of components in the regions of the power grid model within the subset and electrical values of components in the at least one additional region; and providing as output only the simulation results of electrical values of components in the regions of the power grid model within the subset.

Embodiment 2 is the method of embodiment 1, further comprising: receiving, from the user, at least one change to the power grid model; and responsive to verifying that the at least one change is associated with the at least one region in the subset of regions of the power grid model, updating the power grid model to incorporate the at least one change.

Embodiment 3 is the method of embodiment 1, wherein the region is an area of space that is defined by fixed boundary points.

Embodiment 4 is the method of embodiment 3, wherein the fixed boundary points are geographic coordinates.

Embodiment 5 is the method of embodiment 1, wherein the region is an area of space that is defined by an identifier.

Embodiment 6 is the method of embodiment 1, further comprising: providing access only to a result subset of the simulation results based on access privileges associated with a user account.

Embodiment 7 is the method of embodiment 6, wherein the result subset comprises simulation results at a boundary of a region of the regions of the power grid model.

Embodiment 8 is a system comprising: at least one processor; and a data store coupled to the at least one processor having instructions stored thereon which, when executed by the at least one processor, causes the at least one processor to perform the method of any one of embodiments 1-7.

Embodiment 9 is one or more non-transitory computer readable storage media storing instructions that, when executed by at least one processor, cause the at least one processor to perform the method of any one of embodiments 1-7.

Embodiment 10 is a computer-implemented method comprising: obtaining a power grid model that represents a power grid and electrical specifications of grid components, the power grid model comprising a plurality of regions; responsive to an access request from a user, providing access only to a subset of the regions based on access privileges associated with a user account, wherein the user is not permitted to access other regions of the power grid model outside of the subset; receiving, from the user, at least one change to the power grid model; and responsive to verifying that the at least one change is associated with at least one region in the subset of regions of the power grid model, updating the power grid model to incorporate the at least one change.

Embodiment 11 is the method of embodiment 10, further comprising: determining a user group associated with the user; determining access permissions for the user group; and determining, using the access permissions, that at least one change is permitted.

Embodiment 12 is the method of embodiment 10, further comprising: determining a user group associated with the user; determining access permissions for the user group; and determining that the access permissions do not permit the at least one change.

Embodiment 13 is the method of embodiment 12, further comprising: responsive to determining that the access permissions do not permit the at least one change, providing an access notification indicating that access was denied to the user.

Embodiment 14 is a system comprising: at least one processor; and a data store coupled to the at least one processor having instructions stored thereon which, when executed by the at least one processor, causes the at least one processor to perform the method of any one of embodiments 10-13.

Embodiment 15 is one or more non-transitory computer readable storage media storing instructions that, when executed by at least one processor, cause the at least one processor to perform the method of any one of embodiments 10-13.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
accessing a power grid model that represents a power grid and electrical specifications of grid components, the power grid model comprising a plurality of regions;
responsive to an access request from a user, providing access only to a subset of the regions based on access privileges associated with a user account, wherein the user is not permitted to access other regions of the power grid model outside of the subset;
executing a simulation of the power grid model using input from the user, the input indicating simulation parameters for at least one of the regions in the subset, the simulation executed on the regions of the power grid model in the subset and at least one additional region that is not in the subset to produce simulation results including electrical values of components in the regions of the power grid model within the subset and electrical values of components in the at least one additional region; and
providing as output only the simulation results of electrical values of components in the regions of the power grid model within the subset.

2. The computer-implemented method of claim 1, further comprising:
receiving, from the user, at least one change to the power grid model; and
responsive to verifying that the at least one change is associated with the at least one region in the subset of regions of the power grid model, updating the power grid model to incorporate the at least one change.

3. The computer-implemented method of claim 1, wherein the region is an area of space that is defined by fixed boundary points.

4. The computer-implemented method of claim 3, wherein the fixed boundary points are geographic coordinates.

5. The computer-implemented method of claim 1, wherein the region is an area of space that is defined by an identifier.

6. The computer-implemented method of claim 1, further comprising:
providing access only to a result subset of the simulation results based on access privileges associated with a user account.

7. The computer-implemented method of claim 6, wherein the result subset comprises simulation results at a boundary of a region of the regions of the power grid model.

8. A system comprising:
at least one processor; and a data store coupled to the at least one processor having instructions stored thereon which, when executed by the at least one processor, causes the at least one processor to perform operations comprising:
accessing a power grid model that represents a power grid and electrical specifications of grid components, the power grid model comprising a plurality of regions;
responsive to an access request from a user, providing access only to a subset of the regions based on access privileges associated with a user account, wherein the user is not permitted to access other regions of the power grid model outside of the subset;
executing a simulation of the power grid model using input from the user, the input indicating simulation parameters for at least one of the regions in the subset, the simulation executed on the regions of the power grid model in the subset and at least one additional region that is not in the subset to produce simulation results including electrical values of components in the regions of the power grid model within the subset and electrical values of components in the at least one additional region; and
providing as output only the simulation results of electrical values of components in the regions of the power grid model within the subset.

9. The system of claim 8, wherein the operations further comprise:
receiving, from the user, at least one change to the power grid model; and
responsive to verifying that the at least one change is associated with the at least one region in the subset of regions of the power grid model, updating the power grid model to incorporate the at least one change.

10. The system of claim 8, wherein the region is an area of space that is defined by fixed boundary points.

11. The system of claim 10, wherein the fixed boundary points are geographic coordinates.

12. The system of claim 8, wherein the region is an area of space that is defined by an identifier.

13. The system of claim 8, further comprising:
providing access only to a result subset of the simulation results based on access privileges associated with a user account.

14. The system of claim 13, wherein the result subset comprises simulation results at a boundary of a region of the regions of the power grid model.

15. A computer-implemented method comprising:
obtaining a power grid model that represents a power grid and electrical specifications of grid components, the power grid model comprising a plurality of regions;
responsive to an access request from a user, providing access only to a subset of the regions based on access privileges associated with a user account, wherein the user is not permitted to access other regions of the power grid model outside of the subset;
receiving, from the user, at least one change to the power grid model; and
responsive to verifying that the at least one change is associated with at least one region in the subset of regions of the power grid model, updating the power grid model to incorporate the at least one change.

16. The computer-implemented method of claim 15, further comprising:
determining a user group associated with the user;
determining access permissions for the user group; and
determining, using the access permissions, that at least one change is permitted.

17. The computer-implemented method of claim 15, further comprising:
determining a user group associated with the user;
determining access permissions for the user group; and
determining that the access permissions do not permit the at least one change.

18. The computer-implemented method of claim 17, further comprising:
responsive to determining that the access permissions do not permit the at least one change, providing an access notification indicating that access was denied to the user.

19. A system comprising:
at least one processor; and a data store coupled to the at least one processor having instructions stored thereon which, when executed by the at least one processor, causes the at least one processor to perform operations comprising:
obtaining a power grid model that represents a power grid and electrical specifications of grid components, the power grid model comprising a plurality of regions;
responsive to an access request from a user, providing access only to a subset of the regions based on access privileges associated with a user account, wherein the user is not permitted to access other regions of the power grid model outside of the subset;
receiving, from the user, at least one change to the power grid model; and
responsive to verifying that the at least one change is associated with at least one region in the subset of regions of the power grid model, updating the power grid model to incorporate the at least one change.

20. The system of claim 19, wherein the operations further comprise:
determining a user group associated with the user;
determining access permissions for the user group; and
determining, using the access permissions, that at least one change is permitted.
